(19) United States
(12) Patent Application Publication
(10) Pub. No.: US 2003/0156135 A1
(43) Pub. Date: Aug. 21, 2003

(54) Virtual reality system for tradeshows and associated methods

(75) Inventor: William R. Lucarelli, Strongsville, OH (US)

Correspondence Address: Timothy E. Nauman, Esq., Fay, Sharpe, Fagan, Minnich & McKee, LLP, 1100 Superior Avenue, 7th Floor, Cleveland, OH, 44114-2518, US

(73) Assignee: Lucarelli Designs & Displays, Inc.

(21) Appl. No.: 10/271,046

(22) Filed: Oct. 15, 2002

Related U.S. Application Data
(60) Provisional application No. 60/357,461, filed on Feb. 15, 2002.

(51) Int. Cl. G09G 5/00

(52) U.S. Cl. 345/757; 345/850

(57) ABSTRACT

The invention provides a virtual reality system for a tradeshow. In one embodiment, the system includes a first host device for navigating through a three-dimensional (3-D) virtual reality tradeshow. In another embodiment, the system also includes a second host device and a communications network interconnecting the host devices. In another aspect, the invention provides a method for conducting a tradeshow using a virtual reality system a) creating a 3-D virtual reality venue; b) creating one or more 3-D virtual reality exhibit booths, c) compiling a 3-D virtual reality tradeshow; d) creating multimedia files containing supplemental information; e) compiling a virtual reality tradeshow environment; f) authorizing a user to use the virtual reality tradeshow; and g) displaying a visual image of the tradeshow to the user based on the user's position in the tradeshow and updating the tradeshow visual image as the user navigates through the tradeshow.

This application claims the priority of U.S. application Ser. No. 60/3,57,461, filed Feb. 15, 2002.

### BACKGROUND OF INVENTION

The invention relates generally to a virtual reality system for tradeshows. It finds particular application in conjunction with organizing and conducting a tradeshow that is presented to users in a three-dimensional (3-D) virtual reality environment and will be described with particular reference thereto. However, it is to be appreciated that the invention is also amenable to other applications.

Tradeshow exhibitions have been conducted at real venues for years. A problem with conventional tradeshows is that tradeshow participation requires sending equipment, product, samples, literature and other items to a common facility or venue to be erected for display. Transportation, contracted on-site labor, material handling, utilities and other related services and expenses are encountered in order to participate. Occasionally, equipment or products are too large to erect for display or too costly to ship. Participation outside of the country becomes even move difficult and costly. Another problem with conventional tradeshows is that exhibitors and attendees must travel to the venue, stay in hotels, and add considerable cost in travel-related expenses to participate. Some locations are not desirable due to seasonal weather conditions, available housing, and travel distances.

While conventional tradeshows may be suitable for some purposes, participation by corporations, businesses, agencies, attendees and the public is limited to those who feel that the associated expenses or inconvenience are outweighed by certain advantages or opportunities. Undoubtedly, a number of exhibitors and people that could attend and benefit from the exhibition, if the associated expenses were lower and/or attendance was more convenient, opt to limit their participation or not participate at all in the tradeshow.

More recently, Internet-derived tradeshow expositions have been introduced However, current Internet tradeshows merely use hyperlinks in a two-dimensional environment to navigate through a set of web pages. Users participating in current Internet tradeshows are merely experiencing a common Web browsing or surfing session that happens to be related to the particular industry or subject featured by the exposition.

Additionally, throughput or bandwidth of current equipment being used in a network infrastructure limits Internet and other network-based expositions. The bandwidth for end-to-end communications is based on the device in the communications path with the lowest throughput. The device with the lowest throughput limits the performance of the entire communication, creating what is known in the industry as a “bottleneck.” Any piece of equipment in the communications path can create the bottleneck. In order to be compatible with more equipment, the resolution and fidelity of current network-based tradeshows are typically limited. Thus, the quality of the tradeshows is typically poor and limited to simple shapes, textures, and very little high resolution or high fidelity informational media.

While the quality of current network-based tradeshows can be increased for end-to-end broadband communications, there is typically a continuous demand for maximizing the resolution and fidelity until the available bandwidth is used up, merely leading to the same bottleneck problem at a higher performance level.

Thus, there is a particular need for a system in which attendees, exhibitors, promoters, and sponsors can participate in a high resolution, high fidelity simulation of a tradeshow in a 3-D virtual reality environment. There are also needs for options to: 1) operate the system in a standalone mode and 2) maintain the quality of the simulation over networked-equipment with limited throughput.

### BRIEF SUMMARY OF INVENTION

The present invention provides a virtual reality system for tradeshows that meets the above-noted needs and others.

The present invention contemplates a three-dimensional (3-D) virtual environment with devices for attendees, exhibitors, promoters, and sponsors to communicate via a communications network. A plurality of communication devices are connected via the communications network. Each communication device includes an application software and virtual tradeshow data. The virtual tradeshow data includes dimension information and characteristics of the 3-D virtual environment.

In one embodiment, the virtual reality system includes a first host device for navigating through a 3-D virtual reality tradeshow, wherein a visual image of the tradeshow is displayed to a first user based on the first user's current position/location in the tradeshow, wherein the tradeshow visual image is updated in response to navigation through the tradeshow by the first user.

In another embodiment, the virtual reality system also includes a second host device for navigating through the 3-D virtual reality tradeshow, wherein a visual image of the tradeshow is displayed to a second user based on the second user's current position/location in the tradeshow, wherein the tradeshow visual image is updated in response to navigation through the tradeshow by the second user and a communications network interconnecting the first host device and the second host device, wherein the tradeshow visual image displayed to the first user at the first host device includes a first avatar associated with the second user, wherein the position of the first avatar in the tradeshow visual image is updated in response to navigation through the tradeshow by the second user on the second host device and wherein the tradeshow visual image displayed to the second user at the second host device includes a second avatar associated with the first user, wherein the position of the second avatar in the tradeshow visual image is updated in response to navigation through the tradeshow by the first user on the first host device.

In another aspect of the invention, a method for conducting a tradeshow using a virtual reality system is provided. The method includes the following steps: a) creating electronic files defining a 3-D virtual reality venue in which the tradeshow will be conducted; b) creating electronic files defining one or more 3-D virtual reality exhibit booths and positioning the booths within the venue; c) compiling the venue electronic files and the one or more exhibit booth electronic files into a set of electronic files defining a 3-D virtual reality tradeshow; d) creating multimedia files containing supplemental information associated with the tradeshow, e) compiling the tradeshow electronic files and the multimedia files into a set of data files defining a virtual reality tradeshow environment; f) authorizing a first user to use a virtual reality tradeshow software application and the tradeshow environment data files on a first host device associated with the virtual reality system; and g) displaying a first visual image of the tradeshow to the first user based on the first user's initial position in the tradeshow and updating the first tradeshow visual image as the first user navigates through the tradeshow.

In still another aspect of the invention, a method for identifying potential sales leads associated with a 3-D virtual reality tradeshow is provided. The method includes the following steps: a) collecting a set of user profile information from each tradeshow attendee via a first host device; b) assigning a unique user identifier address to each attendee; c) periodically recording the unique user identification address and current position for each attendee as each attendee uses the first host device to navigate through the tradeshow, wherein the information recorded is communicated to a second host device; d) recognizing when any attendee using a first host device has entered a first 3-D virtual reality exhibit booth within the tradeshow; and e) reporting at least some of the user profile information for each attendee that entered the first exhibit booth to a tradeshow exhibitor.

The present invention eliminates many disadvantages of conventional tradeshows, for example, venue selection, shipping and handling of material on-site support services, on-site labor, travel, lodging, and the expenses associated with such items.

Another advantage is that the present invention does not rely on the communications network to update displays from the 3-D virtual environment when a user is navigating through the virtual tradeshow.

Still further features and advantages of the invention will become apparent to those of ordinary skill in the art upon reading and understanding the description of the invention provided herein.

### BRIEF DESCRIPTION OF DRAWINGS

The invention is described in more detail in conjunction with a set of accompanying drawings.

FIG. 1 is a block diagram of a virtual reality system for tradeshows in one embodiment of the invention.

FIG. 2 is a block diagram of a virtual reality system for tradeshows in another embodiment of the invention and is representative of an embodiment of a host device of FIG. 1.

FIG. 3 is an example of a three-dimensional (3-D) rendering from a virtual reality environment for a tradeshow.

FIG. 4 is another example of a 3-D rendering from a virtual reality environment for a tradeshow.

FIG. 5 is an example of an interactive screen generated by application software based on a user's position in a virtual reality environment for a tradeshow.

FIG. 6 is a diagram of one embodiment of the application software depicted in FIG. 2.

FIG. 7 is a diagram of one embodiment of the tradeshow environment data depicted in FIG. 2.

FIG. 8 is a block diagram of a virtual reality system for tradeshows in another embodiment of the invention.

### DETAILED DESCRIPTION

While the invention is described in conjunction with the accompanying drawings, the drawings are for purposes of illustrating exemplary embodiments of the invention and are not to be construed as limiting the invention to such embodiments. It is understood that the invention may take form in various components and arrangement of components and in various steps and arrangement of steps beyond those provided in the drawings and associated description. Within the drawings, like reference numerals denote like elements.

In describing the invention, the following terms have been used

“Virtual reality” refers to an artificial experience that gives a person a sense of presence (i.e., a first-person experience) in an artificial three-dimensional (3-D) scene through sensory stimuli (e.g., visual images, aural cues) and in which actions by the person partially determine what happens in the scene.

“Virtual reality environment” refers to an artificial 3-D interactive environment defined by data files and presented by computer equipment and application software in which a person experiences virtual reality.

“Virtual reality system” refers to a system that includes sufficient computer equipment, application software, and data files to present a virtual reality environment to a user and in which the user experiences virtual reality.

“Avatar” refers to an interactive animation model that represents a current user who is within the virtual reality environment.

“Robot or bot” refers to an interactive animation model that, like an avatar, represents an imaginary person. Typically, bots are used to create a feeling of hustle and bustle to enhance the fidelity of the virtual reality environment. Usually, the number of bots present in the environment is inversely proportional to the number of avatars present.

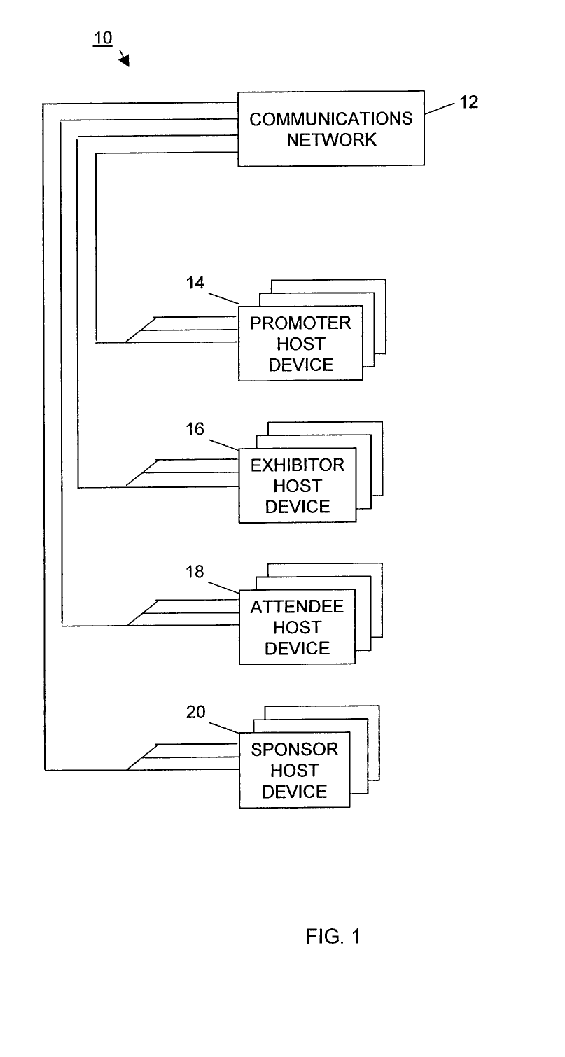

With reference to FIG. 1, a network-based virtual reality system 10 for tradeshows uses a communications network 12 in one embodiment of the invention. In a basic form, the system 10 includes a promoter host device 14, an exhibitor host device 16, and an attendee host device 18 interconnected via the communications network 12. Typically, there is at least one promoter host device 14, a plurality of attendee host devices 18 and a plurality of exhibitor devices 18 in the system 10. A promoter host device 14 may function as a file server as well a user device. Additionally, there may be more promoter host devices 14 and one or more sponsor host devices 20 connected to the communications network 12. Where multiple promoter host devices 14 are provided, one or more promoter host devices 14 may provide file server functions while other promoter host devices 14 may be operated by users. Various combinations of promoter host devices 14, exhibitor host devices 16, attendee host devices 18, and sponsor host devices 20 are contemplated. The network-based virtual reality system 10 provides a platform for organizing and conducting one or more tradeshows in a virtual reality environment. Each tradeshow provides an interactive virtual reality environment to multiple users. The user can interactively navigate through the environment, interact with embedded controls in the environment, interact with software controls, and interact with other users navigating through the tradeshow environment.

As shown, FIG. 1 reflects a networked mode of operation for the tradeshow system 10. In the networked mode, an interactive multi-user 3-D virtual reality tradeshow is presented to each current individual user at a host device. At any one time, each current user is represented and interactively displayed to each current individual user. The networked mode also supports interactive communications between current users (e.g., tradeshow attendees can communicate with one another if so desired).

The host devices are characterized as promoter host devices 14, exhibitor host devices 16, attendee host devices 18, and sponsor host devices 20 according to the type of user logged in and running the tradeshow software application. Users and devices characterized as promoters are associated with firms producing and managing the tradeshow. Exhibitor host devices 16 and exhibitor users are associated with firms that have developed exhibit booths for the tradeshow and made arrangements with the promoter to include the booth in the virtual reality tradeshow environment. Users and devices characterized as attendees are individuals and firms that have made arrangements with the promoter to attend the tradeshow. Sponsor host devices 20 and sponsor users are associated with firms that have developed advertisements and made arrangements with the promoter to include the advertisements in the virtual reality tradeshow environment.

A standalone mode of operation is also contemplated for individual host devices. The standalone mode serves as a backup to the networked mode of operation if network connections are lost or interrupted. In the standalone mode, the interactive virtual reality tradeshow environment is presented to an individual user at an individual host device. The individual user can interactively navigate through the environment, interact with embedded controls in the environment, and interact with software controls. Actions by the individual user may be saved locally and transmitted to other host devices when network connections are restored.

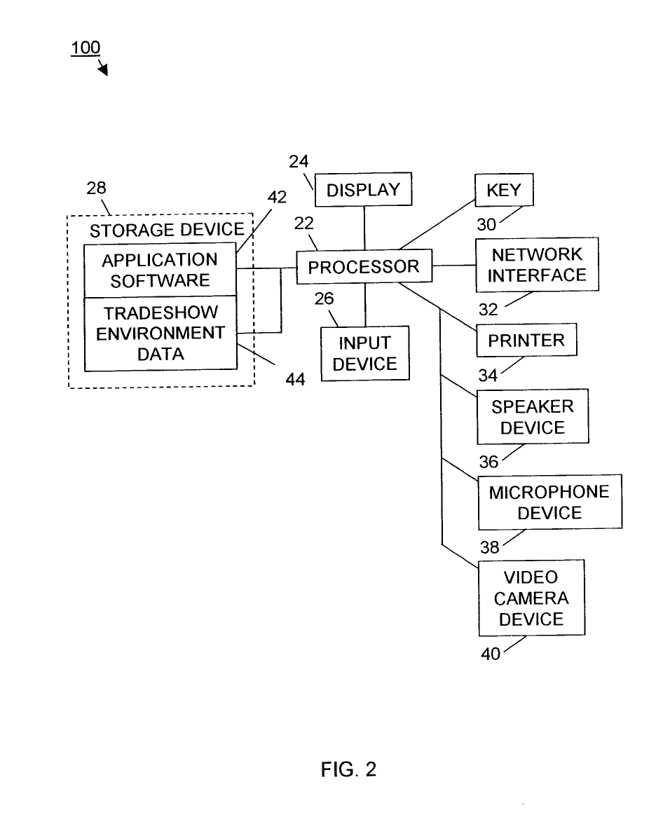

With reference to FIG. 2, a standalone virtual reality system 100 for tradeshows is provided. This embodiment of a system is also representative of an embodiment of a typical host device used in the network-based virtual reality system 10 of FIG. 1. The standalone system 100 and typical host device includes a processor 22, a display 24, an input device 26, a storage device 28, and a key (e g., hardware key, software key) 30. The typical host device in a network-based system 10 also includes a network interface 32. However, the network interface 32 is optional in the standalone system 100. The standalone system 100 and typical host device may also include a printer 34, an audio device (e.g., speakers) 36, a microphone device 38, a video camera device 40, and other types of internal or external devices, depending on the intended uses and specific needs of a particular user.

The standalone system 100 and typical host device is preferably a common form of a computer system. Alternatively, it may be a device dedicated to use for common types of virtual reality environments or a device dedicated to use specifically for a virtual reality tradeshow environment.

The processor 22 is operationally coupled to the other components and controls the standalone system 100. The display 24 may include a cathode ray tube (CRT) display, a flat screen display, a matrix display, an alphanumeric display, or any other type of display or combinations of displays suitable for viewing the combinations of graphics and text associated with the virtual reality tradeshow environment. Exemplary input devices 26 include a keyboard, keypad, control buttons, and a pointing device (i.e., mouse, trackball, glidepad, touch screen, etc.) either individually or in various combinations.

Application software 42 and tradeshow environment data 44 are stored in the storage device 28. The storage device 28 is, for example, a fixed storage device (e.g., hard disk drive), a removable storage device (e.g., CD-ROM drive, floppy disk drive), or a combination of fixed and removable storage devices. The application software 42 and tradeshow environment data 44 are electronic files installed on the fixed storage device, removable storage media, or a combination of fixed and removable storage media. In the standalone system, the application software 42 is typically tailored for an attendee user and need not support interactive communications between multiple users.

Nevertheless, for an attendee host device 18 in the network-based system 10, the application software 42 is tailored for an attendee user and supports interactive communications between multiple users. Additionally, for the other various host devices in the networked-based system 10, the application software 42 may be tailored to the other types of users. For example, promoter application software, exhibitor application software, attendee application software, and/or sponsor application software may be tailored to the specific needs of these different types of users. In particular, promoter application software may include centralized file server functions for distribution of information and data, registration of participants, collection of potential customer sales lead data during a virtual tradeshow, and distribution of the lead data. Similarly, exhibitor application software may include various methods for requesting and displaying current and historical customer lead data for a virtual tradeshow.

The key 30 may include a hardware key, a software key, or a combination of both. An example of a hardware key is a blind plug or a similar type of article that attaches to a port on the standalone system 100 or typical host device and provides a security check for the license to use the application software and/or a virtual reality tradeshow environment. An example of a software key is a password, serial number, or similar type of information that provides an alternate or additional security check for the license to use the application software and/or a virtual reality tradeshow environment.

The network interface 32 provides a communications port for connection to the communications network 12. While the networked mode of operation requires the network interface 32, if network communications are lost or interrupted a host device in the network-based system 10 diverts to standalone operation. The network interface 32 is not required in the standalone system 100.

If included, the printer 34 provides standard print functions to the standalone system or typical host device. The speaker device 36 provides audible stimuli associated with the virtual reality tradeshow environment, audible messages and tones associated with the application software 42, and standard computer sound functions In the network-based system 10, the speaker device 36 also provides the typical host device with audible messages associated with interactive and pre-recorded communications between users.

In the network-based system 10, the microphone device 38, in conjunction with the speaker device 36, permits users of typical host devices to interactively converse with other users in a manner similar to what is commonly known as Internet telephony. The microphone device 38 also permits users to record audio messages.

In the network-based system 10, the video camera device 40, in conjunction with the microphone device 38 and the speaker device 36, permits users of typical host devices to interactively converse with other users in a manner similar to what is commonly known as video conferencing. The video camera device 40, in conjunction with the microphone device 38, also permits users to record video messages.

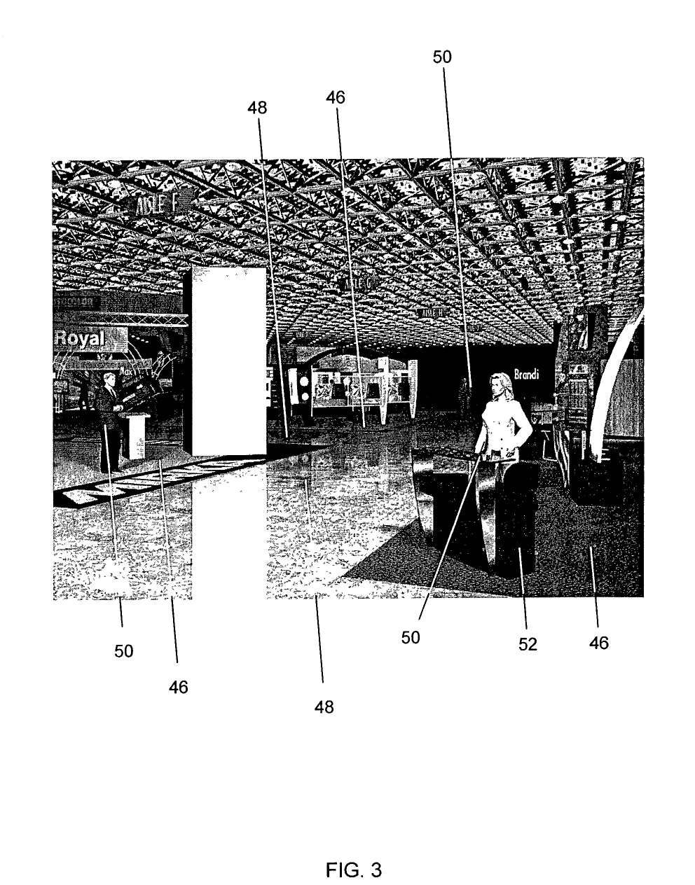

FIG. 3 is an example of a 3-D rendering from a virtual reality environment for a tradeshow. The rendering shows three exhibit booths 46, two aisles 48, and three avatars 50. The aisles 48 separate the exhibit booths 46 and form an intersection. The avatars 50 are models representing users operating the tradeshow software application in networked mode. The two closest avatars 50 in the rendering represent exhibitor users. One exhibitor user, the right-most avatar 50, is standing behind a display counter 52 where demonstrations may be performed. The other exhibitor user, the left-most avatar 50, is standing in an open area of the exhibit booth 46 and prepared to converse with the next attendee entering the booth 46. The avatar 50 in the background represents an attendee user walking down a first aisle 48 and approaching the intersection with a second aisle 48.

The view depicted in FIG. 3 is from a perspective of a fourth avatar (not shown) representing another attendee user navigating through the virtual reality tradeshow environment. As the attendee user navigates through the tradeshow, the display is interactively updated to create a sense of actually walking through a live tradeshow, reflecting the 3-D and virtual reality aspects of the tradeshow.

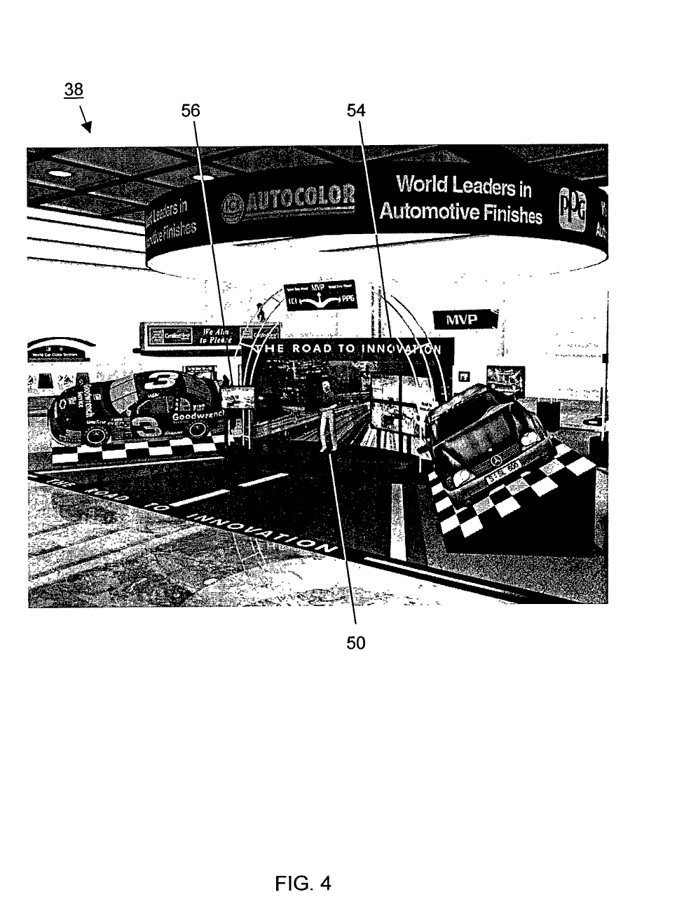

Another example of a 3-D rendering from a virtual reality environment for a tradeshow is shown in FIG. 4. The rendering shows a portion of an exhibit booth 46. The avatar 50 is shown standing in the exhibit booth 46 moving from a 4-screen flat panel video display 54 to a single flat panel display 56. Both displays 54, 56 are showing a pre-recorded motion video In addition to motion video, exhibit booths can include supplemental information in pre-recorded animation sequences, interactive animation models, still-frame pictures, graphic images, slide presentations, lighting and other special effects, audio tones, pre-recorded audio narrations, pre-recorded audio messages, documents, controls (e.g., buttons or pop-up menus), and hyperlinks. Such features can also be initiated automatically based on the user's proximity to an item within the exhibit booth or by selection of embedded controls.

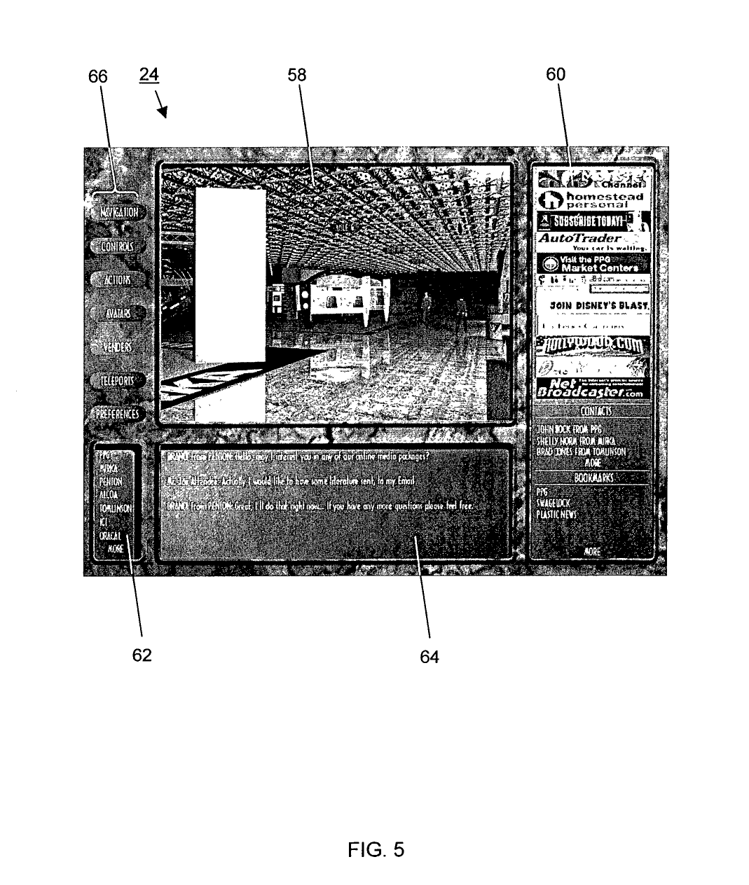

In FIG. 5, an example of an interactive screen (i.e., graphical user interface (GUI)) created by the application software 42 for the display 24 of an attendee host device 18 is provided. The exemplary interactive screen includes four frames 58, 60, 62, 64 and a column of control buttons 66. One frame is a virtual reality frame 58. The virtual reality frame 58 shows a 3-D rendering from a virtual reality environment for a tradeshow similar to FIG. 3. Another frame is an advertisement frame 60 and provides advertisements from various sponsors of the tradeshow. Similar to exhibit booths, but at a smaller scale, advertisements can include pre-recorded motion video, pre-recorded animation sequences, interactive animation models, still-frame pictures, slide presentations, lighting and other special effects, audio tones, pre-recorded audio narrations, pre-recorded audio messages, documents, controls (e.g., buttons or pop-up menus), and hyperlinks. Although not shown, advertisements can also be displayed on floors, walls, ceilings, signs, banners, fountains, etc. within the virtual reality tradeshow environment. The advertisement frame 60 also includes a list of exhibitors (i.e., CONTACTS) captured by the attendee, a list of exhibitor booths (i.e., BOOKMARKS) created by the attendee, and a control button (i.e., MORE) to access additional information and/or additional advertisements.

The third frame in the interactive screen example is an exhibitor list frame 62. The exhibitor list frame 62 shows a portion of the exhibitors participating in the tradeshow and a control button (i.e., MORE) to page or scroll through additional exhibitors. The fourth frame in the example is an instant text message frame 64 that shows chronological instant text messages between the user (e g., attendee) and other users (e.g., exhibitors) as the user continues to navigate through the virtual tradeshow environment. As shown, instant text messages may be initiated by attendees or exhibitors. After receiving an instant text message, the user (e.g., attendee) may respond or ignore the message. The column of control buttons 66 permit the attendee to operate the 3-D virtual tradeshow application software 42 and to navigate through the tradeshow environment.

In alternate interactive screens, the four frames 58, 60, 62, 64 and the column of control buttons 66 of the exemplary interactive screen can be configured in any arrangement, additional or alternate frames can be included, additional or alternate control buttons can be included, and multiple displays can be used to display similar or re-configured information.

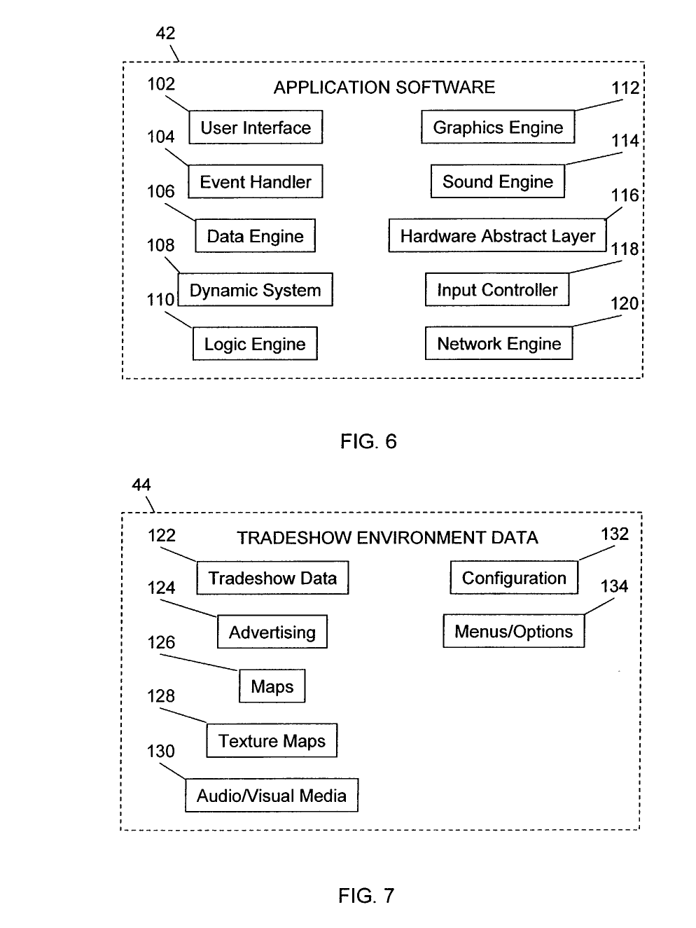

From an operational sense, the network-based system 10 permits attendees, exhibitors, promoters, and sponsors to participate in an interactive tradeshow within a virtual reality environment via the communications network 12. The communications network 12 interconnects a plurality of host devices. Each host device includes application software 42 (FIG. 6) and tradeshow environment data 44 (FIG. 7). The application software 42 is preferably installed on a fixed storage device (e.g., hard disk drive). The tradeshow environment data 44 includes electronic files that define the virtual reality tradeshow environment and are preferably on removable storage media (e.g., CD-ROM, DVD-ROM). Alternatively, the application software 42 and tradeshow environment data 44 or components thereof may be installed on a fixed storage device or removable storage media in any combination.

The tradeshow environment data 44 (FIG. 7) includes dimensional information and content information that serves to define the specific virtual reality tradeshow environment for a given tradeshow. More specifically, the tradeshow environment data 44 includes information associated with, for example, the venue (i.e., exhibit hall), exhibit booths, private conference rooms, auditoriums, avatars, bots, signage, and advertisements. The information associated with the venue further includes a map showing locations of, for example, exhibit booths, private conference rooms, and auditoriums and mapping coordinates for the various items within the environment. The information associated with each exhibit booth, private conference room, and auditorium further includes information associated with products, brochures, literature, documents, demonstrations, and schedules for certain activities. The information associated with signage further includes directional and instructional information. The information associated with advertisements further includes information associated with products, brochures, literature, and documents.

The tradeshow environment data 44 is comprised of the 3-D virtual reality tradeshow and supplemental information in various electronic files. The electronic files includes various combinations of multimedia, graphics, audio, text, and script files, including pre-recorded motion video, pre-recorded animation sequences, interactive animation models, still-frame pictures, graphic images, slide presentations, lighting and special effects, audio tones, pre-recorded audio narrations, pre-recorded audio messages, documents, controls, and hyperlinks, although it will be appreciated that this list is not exhaustive of the various types/combinations of electronic files. The pre-recorded animation sequences include, among others, waving or flapping, rotation, panning, zooming, and disassembly/cross sectioning of products. The interactive animation models include a model for navigation through the virtual reality environment and models for avatars, bots, and products within the environment. Graphics associated with the various forms of information may further include, for example, wire-frame structures, lines, fills, shading, and textures. The script files define circumstances that control which elements from the virtual reality environment are displayed to a given user and may further control the behavior of certain elements, particularly the interactive animation models.

The application software 42 constructs interactive screens, particularly the virtual reality frame, from the tradeshow environment data 44 based on the position of the user in the virtual reality tradeshow as schematically represented in FIG. 2 and illustrated in FIGS. 3-5.

The communications network 12 transfers information about avatars 50 representing attendee users, exhibitor users, promoter users, and sponsor users currently within the virtual tradeshow environment, including positional information, interactive communications, and asynchronous communications. Interactive communications may include instant text messages, voice telephony, and video conferencing Asynchronous communications may include electronic mail with text messages, recorded audio messages, and/or recorded video messages. The communication network 12 may transfer such information or any component of such information in approximately real-time. The file server can process and manage network communications related to exhibit booths visited, items collected, movement, and actions initiated by various users. This information about attendee users is particularly useful to exhibitors and sponsors for potential sales leads and targeted marketing

The application software 42 (FIG. 7) is used to read, interpret, and display the tradeshow environment data from, for example, the removable storage media (e g, CD-ROM) The application software 42 also provides an interactive display screen to the user of the host device via the display 24. The application software 42 preferably includes an interface to an input device 26 that enables the user to navigate and control movement and actions within the 3-D virtual tradeshow environment. The interface may include control buttons 66 on the display and fields for entering commands and messages (FIG. 5). The application software 42, for example, provides hardware and software initialization, network communications, data interpretation and presentation, server communications, user identification and authentication, tradeshow registration and authorization, and time codes/stamps user actions and tradeshow activities. Generally, the application software 42 does not include data or information defining a specific virtual reality tradeshow environment.

The attendee, exhibitor, promoter, or sponsor navigates within the 3-D virtual tradeshow environment using the application software 42. The application software 42 reads CAD data, graphics, textures, components, and dimensions from the tradeshow environment data 44 on, for example, removable storage media (e.g., CD-ROM) and renders a 3-D view of the virtual reality tradeshow environment to the display 24 based on the position of the user in the environment. Additionally, the application software 42 supports network communications with other users.

The application software 42 runs on a networked computer system, a networked computer terminal, a dedicated host device designed for use with networked virtual reality environments (e.g., a kiosk, play station, computer), or a dedicated host device specifically designed for use with networked virtual reality tradeshow environments. Patches and add-ons to the application software 42 may be downloaded via the communications network 12 or provided on removable media similar to or along with the tradeshow environment data 44.

The application software 42 may also run in a standalone mode if, for example, network communications are disabled, defective, or not available. When used in the standalone mode, the host device may capture or store electronic mail and other network communications (i.e., avatar positional information, etc.) and subsequently transfer them after network communications are restored.

The tradeshow environment data 44 is typically installed on the host device and accessible to the application software 42 so that the information can be displayed quickly in high resolution Local storage of the tradeshow environment data 44 improves the fidelity and performance of the virtual reality experience and enables higher image resolution for the renderings over, for example, centralized storage on a file server. The tradeshow environment data 44 can be time stamped to only operate between predetermined dates. It is also contemplated that the tradeshow environment data 44 can be downloaded from the communication network 12 to the local storage device 28 on the host device, rather than residing on removable storage media (e.g., CD-ROM). The tradeshow environment data 44 is downloaded in advance of operations or can be downloaded as needed during operations. However, bandwidth constraints may reduce the fidelity and performance of the virtual reality experience or reduce the resolution of the images rendered if the tradeshow environment data 44 is downloaded as needed.

The communications network 12 can be, for example, the Internet, an internet, an intranet, a local area network, a public switched telephone network (PSTN), or a cable television network. The communications network 12 may require the user to be a subscriber for access to the network. For example, access to the Internet is typically through an Internet service provider, access to the PSTN is typically through a local telephone company or a wireless telephone service provider, access to a cable television network is typically through a local cable television service provider. In addition, any communications technology suitable for transfer of information related to movement of the avatars within the virtual reality tradeshow environment, interactive communication between multiple users, and the application software 42 and/or tradeshow environment data 44 may be adopted. The communications network 12 may use various communications technologies, including telephone wire, wireless, or fiber, cable television, radio frequency, infrared, or other technologies, individually or in various combinations.

In planning and preparing for a tradeshow on a virtual reality system 10, 100, the process begins when a promoter identifies a particular tradeshow for a targeted business space and schedules a time when the tradeshow would be conducted. Next, the promoter typically chooses a venue design and begins selling space within the virtual exhibit hall to exhibitors for exhibit booths, auditoriums, and private conference rooms for specific dates and times during the tradeshow Promoters also begin selling advertisement space within the virtual reality tradeshow environment and begin promoting and advertising the coming show to maximize participation by exhibitors, sponsors, and attendees. Promoters may also offer exhibitors and sponsors add-on services such as literature distribution, inquiry costs, sound clips, product animation/demonstration, movie presentations, pop-up advertising, voice telephony, video conferencing, and outside linking and redirects. Advertisements within the virtual reality tradeshow can be placed in pop-up windows and ads can be selected for the window based on information contained in an attendee's user profile. Pop-up advertisement windows can follow an avatar through the tradeshow environment or can be associated with specific coordinates or items within the environment.

The exhibitor develops a 3-D virtual reality exhibit booth environment or contracts with a designer for the development thereof The exhibit booth environment includes a set of 3-D CAD files. The 3-D CAD files typically include wire-frame structures, lines, fills, shading, and textures defining graphic images. Combinations of such graphic images along with script files may further define interactive animation models and slide presentations. The 3-D CAD files may further include supplemental information, for example, pre-recorded motion video, pre-recorded animation sequences, still-frame pictures, lighting and special effects, audio tones, pre-recorded audio narrations, pre-recorded audio messages, and documents. Script files and controls monitor a user's position within the virtual reality tradeshow environment and define which items are rendered to the display and may further control the behavior of certain elements, particularly the interactive animation models. Controls may include automatic controls based on proximity of the user to an item and user-activated controls.

Next, the exhibitor submits the 3-D CAD files to the promoter in a predetermined file format. The promoter tests the exhibitor-supplied 3-D CAD files and develops a floor plan for the tradeshow. The promoter accumulates 3-D CAD files for each exhibit booth of a given tradeshow into a 3-D virtual reality tradeshow environment based on the floor plan. The completed virtual reality tradeshow environment is saved and stored; or is copied to removable storage media (e.g., CD-ROM) for distribution to attendees, exhibitors, and sponsors

The promoter pre-registers attendees and collects attendee profile information and payments associated with pre-registration. For example, attendee profile information includes the attendee's name, company or firm name, title, and address. The attendee profile information will more than likely also include detailed information that an exhibitor can use to open communication with a current visitor to the exhibitor's booth, prioritize potential sales leads relating to the attendees, and target further contacts with the attendee to his or her particular interests. For example, attendee profile information may also include number of employees in the company, company's gross revenue, attendee's buying authority, type of industry, areas of interest, buying needs, and other information.

The number of employees in firm profile data element, for example, may allow the attendee to select between a number of ranges (e.g., ten or less, 11 to 50, 51 to 100, or 100 or more). The gross revenue profile data element, for example, may also allow the attendee to select between a number of ranges (e.g., less than $1,000,000, $1,000,000 to $5,000,000, or more than $5,000,000 00). The attendee's buying authority profile data element, for example, may allow the attendee to select between suggest or recommend, buyer or agent, or not involved in buying. The type of industry profile data element, for example, may allow the attendee to select manufacturing, technical services, marketing/advertising, and/or financial/professional. The area of interest profile data element, for example, may allow the attendee to select information technology (IT) systems, software, wireless devices, video systems, satellite links, client/server systems, and/or other interests to be written in by the attendee. The buying needs profile data element, for example, may allow the attendee to select between a number of time ranges (e.g., plan to purchase within six months, plan to purchase within one year, or no immediate buying plans). The other areas of interest profile data element, for example, may allow the attendee to select plant equipment, point-of-sale (POS) systems, supply chain/logistics, transportation management, and/or other interests to be written in by the attendee.

Once attendees are pre-registered, they are licensed to use the virtual reality tradeshow application software 42 (if they are not already so licensed) and the tradeshow environment data 44 for the particular tradeshow they have selected. Attendees may also license, purchase, or already own a host device compatible with the application software 42 and the tradeshow environment data 44. The promoter may send the appropriate application software 42, tradeshow environment data 44, and hardware to attendees, exhibitors, and sponsors to enable them to participate in a particular tradeshow. The hardware may include an entire host device 16, 18, 20, individual components thereof, and/or the key (e.g., hardware key, software key) 30 (FIG. 2).

The promoter typically maintains at least one promoter host device 14 as a file server. The file server may have a fixed or static IP address for each tradeshow Access to the IP address for a tradeshow may be restricted until the tradeshow start date, completion of tradeshow registration, and payment of fees to the promoter. The file server collects, processes, and manages static and dynamic IP addresses for identification of tradeshows, promoter users, exhibitor users, attendee users, and sponsor users. The file server can also include web page and dynamic content redirects. Certain tradeshows may use multiple file servers to accommodate more exhibit booths and/or more users, multiple languages, demand for higher bandwidth, and as a method for segmenting the tradeshow.

The promoter provides exhibitor users with a dynamic IP address for identification and the coordinates of their exhibit booth 46 within the tradeshow. Attendees are also given a dynamic IP address and a time schedule for staffing of the exhibit booths within the tradeshow. The promoter also gives the attendee users the IP address or similar unique identifier of each exhibitor or the location of each exhibitor booth. This information facilitates navigation to exhibitor booths and communication with an exhibitor. The schedule may also include times when presentations, demonstrations, and open forums are to be conducted in the exhibit booths or auditoriums.

Typically, the application software 42 and tradeshow environment data 44 is time coded to work on the specific dates that the virtual tradeshow will be in operation. Once the application software 42 and tradeshow environment data 44 are loaded, the host device 16, 18, 20 allows attendees, exhibitors, and sponsors to create an avatar, to navigate and interact within the virtual reality tradeshow environment, and to communicate with other users associated with the tradeshow. Usually, the promoter will establish a temporary IP address on the file server to test the installation and setup of the application software 42 and tradeshow environment data 44 on each host device and network communications between the host device and the file server.

When starting a tradeshow session, the attendees, exhibitors, and sponsors are requested to log in using their alphanumerical identification. The exhibitors are typically directed to their virtual exhibit booth 46 as staff. Exhibitors are also permitted to roam the virtual tradeshow.

Attendees are typically first directed to registration for confirmation of profile information and payment of fees associated with registration. Alternatively, attendee profile information, as described above, may be collected at registration, rather than pre-registration. Once registered, an IP address is downloaded from the file server to the host device and the attendee user may enter the virtual tradeshow via the main entrance of the virtual exhibition hall As the attendee's avatar navigates and interacts within the virtual exhibit hall, the attendee may communicate with exhibitors using several methods, such as interactive or asynchronous communications. Interactive communications may include instant text messaging, voice telephony, and video teleconferencing. Asynchronous communications include electronic mail with text messages, recorded audio messages, and/or recorded video messages. The attendees may also communicate with sponsors using asynchronous communications.

When an attendee enters an exhibit booth, the attendee's IP address is captured and associated with an IP address for the exhibitor. Since the attendee profile is associated with the attendee's IP address, the promoter can make the attendee profile information available to the exhibitor during and/or after the attendee enters the exhibitor's booth. The promoter may choose to make this information available as part of an exhibitor's original fee or collect additional fees for profile information. Various fee structures can be used based on the timing, media, and format for delivery of the profile information. When exhibitors are given the profile information associated with each attendee that visits their exhibit booth, they may make use of such information immediately by initiating an interactive communication with the attendee while they are in the booth or retain the information for future reference and follow-up with them as a prospective sales lead after the tradeshow.

Attendees may request literature, view graphics, video, and demonstrations of products or services. If an attendee requests literature, a document containing the literature may be viewed and/or printed on a network or local printer. The graphics, video, and demonstrations may include 3-D representations and animations associated with the exhibitor's products or services. Requests for information may access files (e.g., help, frequently asked questions, and libraries) included in the tradeshow environment data 44, may be directed to an exhibitor in a message, or may hyperlink or be redirected to external web pages providing further details about exhibitor's products and/or services. Presentation of information to a given user may be initiated by the attendee, exhibitor, sponsor, or promoter, depending on the circumstances. For example, when an attendee enters into a presentation or demonstration area of a booth, a pop-up window may open running a pre-recorded motion video. In another example, an attendee can select a product or a designated control and a pop-up window may open with a still-frame picture, a pre-recorded animation sequence, or an interactive animation model associated with the product.

Attendees may also attend seminars in auditoriums within the virtual reality tradeshow environment or conferences in private conference rooms within the environment. Seminars and conferences are also interactive and depicted in 3-D, like the virtual reality tradeshow. Access to seminars and conferences may be restricted to authorized users based on a user's terms of registration (i.e., license) for the tradeshow. Hence, exhibitors may reserve auditoriums or private conference for certain periods of time from a promoter. Attendees may be authorized to enter public seminars in auditoriums based on their terms of registration. However, for private conferences, special privileges may be required in order for exhibitor users and attendee users to have access to the conference room. Such privileges may be granted by the promoter based on an exhibitor's reservation and authorized attendee list. A private conference room can be used to conduct meetings and/or presentations using interactive communications, including instant text messaging, interactive voice telephony, and video conferencing.

The tradeshow may open at different times for specific types of attendees, such as buyers, distributors, owners, affiliates, etc. or based on geographic location (i.e., taking into account time zones). The length and content of a tradeshow can vary depending on the preferences of the promoter and the type of audience targeted

With reference to FIG. 6, a diagram of one embodiment of the application software 42 (FIG. 2) is provided In this embodiment, the application software 42 is comprised of various lower level components, including a user interface component 102, an event handler component 104, a data engine component 106, a dynamic system component 108, a logic engine component 110, a graphics engine component 112, a sound engine component 114, a hardware abstract layer component 116, an input controller 118, and a network engine 120.

With reference to FIG. 7, a diagram of one embodiment of the tradeshow environment data 44 (FIG. 2) is provided. In this embodiment, the tradeshow environment data 44 is comprised of various lower level components, including a tradeshow data component 122, an advertising component 124, a maps component 126, a texture maps component 128, an audio/visual media component 130, a configuration component 132, and a menus/options component 134.

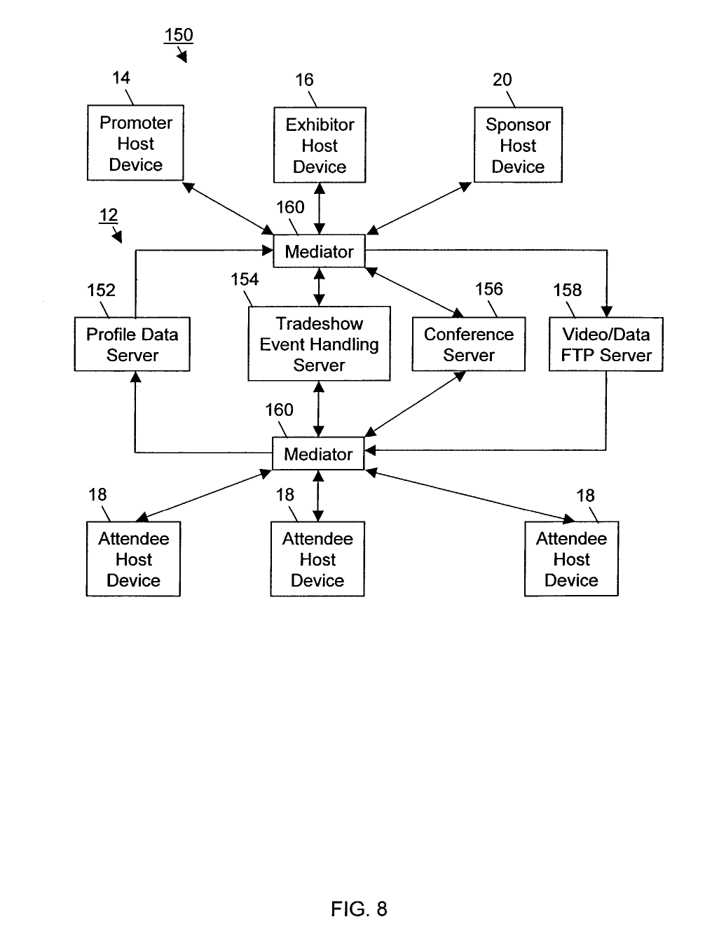

With reference to FIG. 8, a network-based virtual reality system for tradeshows 150 uses a communications network 12 in another embodiment of the invention. Similar to the system 10 of FIG. 1, a basic form of this embodiment of a network-based virtual reality system 150 includes the communications network 12, one or more exhibitor host devices 16, and multiple attendee host devices 18. The system 150 may also include one or more promoter host devices 14 and/or one or more sponsor host devices 20. In this embodiment, the communications network 12 includes a profile data server 152, a tradeshow event handling server 154, a conference server 156, a video/data FTP server 158, and one or more mediator interface devices 160.

The profile data server 152 handles data packets transfers associated with collection and distribution of attendee profile information and the associated data elements The tradeshow event handling server 154 manages data files and processes data packets created by users using the virtual reality tradeshow application software 42 to navigate through a tradeshow. The data processed by the tradeshow event handling server 154 is related to movement of users within the tradeshow environment and other global events. As the tradeshow event handling server 154 collects data from users of a given virtual reality tradeshow it transmits positional changes to all host devices with users that are logged into the particular tradeshow When any user changes position in the tradeshow locally, a data packet is sent to the tradeshow event handling server 154, the server processes the tradeshow event and distributes this data to all other users associated with the tradeshow. The conference server 156 handles data packets or requests for private conferences, video conferences, voice telephony, and other types of interactive telecommunications. The video/data file transfer protocol (FTP) server 158 manages large files, such as video, graphics, software demonstrations, patches, or other data not provided on removable local storage media. In alternate embodiments, these functions may be grouped on one or more servers in any combination.

A mediator interface device 160 is an interface that monitors the transfer of data packets. Certain types of data packets that may require more bandwidth may be filtered out and routed to alternate servers so that bottlenecks are not created on the tradeshow event handling server 154. For example, registration and the collection of attendee profile data packets may be filtered and routed to the profile data server 152; a data pack or request for a private conference, video conference, voice telephony, or other types of telecommunications may be filtered and redirected to the conference server 156; and large files such as video, graphics, software demonstrations, patches, or other data not provided on the soft architecture may be filtered and downloaded via the video/data server FTP server 158. The mediator interface device 160 observes, filters, and processes the data packets and redirects the request to the appropriate server to conserve bandwidth on the tradeshow event handling server 154. In alternate embodiments, the mediator interface device 160 may be contained within the tradeshow event handling server 154 or between the server and clients.

In an exemplary implementation of the system 150, an attendee logs on to register and is bounced to the profile data server 152 to avoid sending the larger data packets associated with registration to the tradeshow event handling server 154. An exhibitor can obtain the attendee profile information by retrieving the data from the profile data server 152 rather than storing and retrieving this information from the tradeshow event handling server 154.

While the invention is described herein in conjunction with exemplary embodiments, it is evident that many alternatives, modifications, and variations will be apparent to those skilled in the art. Accordingly, the embodiments of the invention in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

What is claimed is:

1. A virtual reality system for a tradeshow, including:
a first host device for navigating through a three-dimensional virtual reality tradeshow, wherein a visual image of the tradeshow is displayed to a first user based on the first user's current position in the tradeshow, wherein the tradeshow visual image is updated in response to navigation through the tradeshow by the first user.

2. The virtual reality system for a tradeshow set forth in claim 1, wherein an additional visual image associated with an item depicted in the tradeshow visual image is displayed to the first user in response to the first user's current position in the tradeshow within a predetermined proximity of the item depicted in the tradeshow.

3. The virtual reality system for a tradeshow set forth in claim 1, wherein a control is included in the tradeshow visual image and associated with an item depicted in the tradeshow visual image, wherein an additional visual image associated with the item associated with the control is displayed to the first user in response to the first user's interaction with the control.

4. The virtual reality system for a tradeshow set forth in claim 1, the first host device further including:
a display device,
an input device;
a storage device, and
a processor operationally coupled to the display device, input device, and storage device.

5. The virtual reality system for a tradeshow set forth in claim 4, the storage device further including:
a first storage module for storing a virtual reality tradeshow software application; and
a second storage module for storing a set of data files on a removable media, wherein the set of data files define the three-dimensional virtual reality tradeshow and supplemental information associated with the tradeshow in a tradeshow environment.

6. The virtual reality system for a tradeshow set forth in claim 4, the first host device further including:
an audio device operationally coupled to the processor.

7. The virtual reality system for a tradeshow set forth in claim 6, further including:
a second host device for navigating through the three-dimensional virtual reality tradeshow, wherein a visual image of the tradeshow is displayed to a second user based on the second user's current position in the tradeshow, wherein the tradeshow visual image is updated in response to navigation through the tradeshow by the second user; and
a communications network interconnecting the first host device and the second host device;
wherein the tradeshow visual image displayed to the second user at the second host device includes a first avatar associated with the first user, wherein the position of the first avatar in the tradeshow visual image is updated in response to navigation through the tradeshow by the first user on the first host device; and
wherein the tradeshow visual image displayed to the first user at the first host device includes a second avatar associated with the second user, wherein the position of the second avatar in the tradeshow visual image is updated in response to navigation through the tradeshow by the second user on the second host device.

8. The virtual reality system for a tradeshow set forth in claim 7, the first host device further including:
a microphone device operationally coupled to the processor, and
a video camera device operationally coupled to the processor, and
the second host device including.
a display device;
an input device;
a storage device;
an audio device;
a microphone device;
a video camera device; and
a processor operationally coupled to the display device, input device, storage device, audio device, microphone device, and video camera device.

9. The virtual reality system for a tradeshow set forth in claim 8, wherein the first user using the first host device and the second user using the second host device communicate interactively via instant text messaging, voice telephony, or video conference over the communications network.

10. The virtual reality system for a tradeshow set forth in claim 8, wherein the first user using the first host device and the second user using the second host device communicate asynchronously via electronic mail over the communications network.

11. A method for conducting a tradeshow using a virtual reality system, comprising the following steps.
a) creating electronic files defining a three-dimensional virtual reality venue in which the tradeshow will be conducted;
b) creating electronic files defining one or more three-dimensional virtual reality exhibit booths and positioning the booths within the venue,
c) compiling the venue electronic files and the one or more exhibit booth electronic files into a set of electronic files defining a three-dimensional virtual reality tradeshow,
d) creating multimedia files containing supplemental information associated with the tradeshow;
e) compiling the tradeshow electronic files and the multimedia files into a set of data files defining a virtual reality tradeshow environment;
f) authorizing a first user to use a virtual reality tradeshow software application and the tradeshow environment data files on a first host device associated with the virtual reality system; and
g) displaying a first visual image of the tradeshow to the first user based on the first user's initial position in the tradeshow and updating the first tradeshow visual image as the first user navigates through the tradeshow.

12. The method set forth in claim 11, further comprising the following steps:
h) authorizing a second user to use the software application and the tradeshow environment data files on a second host device associated with the virtual reality system; and
i) displaying a second visual image of the tradeshow to the second user based on the second user's initial position in the tradeshow and updating the second tradeshow visual image as the second user navigates through the tradeshow, wherein the second tradeshow visual image includes a first avatar associated with the first user, wherein the position of the first avatar in the second tradeshow visual image is updated in response to navigation through the tradeshow by the first user on the first host device, wherein the first tradeshow visual image displayed to the first user includes a second avatar associated with the second user, wherein the position of the second avatar in the first tradeshow visual image is updated in response to navigation through the tradeshow by the second user on the second host device.

13. The method set forth in claim 12, further comprising the following step:
j) transmitting interactive communications between the first user using the first host device and the second user using the second host device

14. The method set forth in claim 13, wherein the interactive communications in step j) include instant text messaging, voice telephony, or video conferencing.

15. The method set forth in claim 12, further comprising the following step:
j) transmitting asynchronous communications between the first user using the first host device and the second user using the second host device, wherein the asynchronous communications include electronic mail.

16. A method for identifying potential sales leads associated with a three-dimensional virtual reality tradeshow, comprising the following steps:
a) collecting a set of user profile information from each tradeshow attendee via a first type of host device associated with an attendee of the tradeshow,
b) assigning a unique user identification address to each attendee;
c) periodically recording the unique user identification address and current position for each attendee as each attendee uses the first type of host device to navigate through the tradeshow, wherein the information recorded is communicated to a second type of host device associated with a promoter of the tradeshow,
d) recognizing when any attendee using a first type of host device has entered a first three-dimensional virtual reality exhibit booth within the tradeshow, and
e) reporting the user profile information for each attendee that entered the first exhibit booth to a tradeshow exhibitor associated with the first booth on a third type of host device.

17. The method set forth in claim 16, wherein the user profile information in steps a) and e) includes an attendee's name, a name of a firm associated with the attendee, an attendee's title, and an address associated with the attendee.

18. The method set forth in claim 16, step e) further comprising the following step:
f) reporting the user profile information for an attendee to the tradeshow exhibitor associated with the first booth on the third type of host device for a period of time after the attendee first entered the first booth.

19. The method set forth in claim 16, step e) further comprising the following step:
f) reporting the user profile information for each attendee currently present within the first exhibit booth to the tradeshow exhibitor associated with the first booth on the third type of host device.

20. The method set forth in claim 16, further comprising the following steps:
f) recognizing when any attendee using a first type of host device has entered each three-dimensional virtual reality exhibit booth within the tradeshow, and
g) reporting the user profile information and each exhibit booth within the tradeshow entered for each attendee that entered the first exhibit booth to a tradeshow exhibitor associated with the first booth on the third type of host device.
